(19) United States
(12) Patent Application Publication
(10) Pub. No.: US 2012/0239662 A1
(43) Pub. Date: Sep. 20, 2012

(54) DOCUMENT MANAGEMENT APPARATUS AND DOCUMENT MANAGEMENT METHOD

(75) Inventor: Yusuke Tanaka, Kawasaki-shi (JP)

(73) Assignee: CANON KABUSHIKI KAISHA, Tokyo (JP)

(21) Appl. No.: 13/418,506

(22) Filed: Mar. 13, 2012

(30) Foreign Application Priority Data
Mar. 17, 2011 (JP) 2011-059249

(51) Int. Cl. G06F 17/30

(52) U.S. Cl. 707/741; 707/736; 707/E17.014

(57) ABSTRACT

According to the present invention, a document template and a plurality of document generated based on the document template are registered in association with each other. A document including a search term is searched. A document which includes the search term in a portion corresponding to the document template and a document which includes the search term in a portion other than the document template are displayed in an identifiable manner. In a full-text search, a user can identify a document hit based on a text originally included in the document template and a document hit based on the portion (portion specific to a document input by the user) other than the document template.

### BACKGROUND OF THE INVENTION

1. Field of the Invention

The present disclosure relates to a document management apparatus and a document management method for enabling a full-text search of a registered document, and a program thereof.

2. Description of the Related Art

There is a full-text search as a technique for searching a document registered in a document management system. However, in a conventional full-text search, when searching a document generated from a document template, it is not determined whether a portion matching a search term is a text originally included in the document template or a text specific to the document. Therefore, if the search term is originally included in the document template, there is a problem that a large amount of all documents generated from the document template is hit and the number of unnecessary search results is increased.

Japanese Patent Application Laid-Open No. 5-225240 discusses a technique in which an element such as a title, an author name, or a paragraph is designated, a structured document is searched based on the designated element, and a portion of the designated element is extracted. However, Japanese Patent Application Laid-Open No. 5-225240 does not consider whether the structured document is generated from the document template. More specifically, it is not determined whether the element in the structured document is the text originally included in the document template.

### SUMMARY OF THE INVENTION

According to the present disclosure, a document management system that performs a full-text search of a registered document includes a registration unit configured to register a document template and a plurality of documents generated based on the document template in association with each other, a search unit configured to search whether each of the documents registered by the registration unit includes a search term, and a display unit configured to display the document including the search term, searched by the search unit, as a search result. The display unit displays, in an identifiable manner, a document that includes the search term only in a portion corresponding to the document template and a document that includes the search term in a portion other than the document template with respect to the documents including the search term.

According to the present invention, the document management system enables the presentation of a proper search result in a full-text search, free from a text originally included in a document template.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the disclosure.

FIG. 1 illustrates a system configuration of a document management system according to exemplary embodiments disclosed herein.

FIG. 2 illustrates a hardware configuration of the document management system according to exemplary embodiments disclosed herein.

FIG. 3 illustrates a software configuration of the document management system according to exemplary embodiments disclosed herein.

FIG. 4 illustrates a registration flowchart of a document based on a document template in the document management system according to exemplary embodiments disclosed herein.

FIG. 5 illustrates an example of a data structure indicating association between a document and a document template in the document management system according to exemplary embodiments disclosed herein.

FIG. 6 illustrates a document search flowchart for executing a full-text search in the document management system according to the first exemplary embodiment disclosed herein.

FIG. 7 illustrates an example of a search result list in the document management system according to the first exemplary embodiment disclosed herein.

FIG. 8 illustrates a search result display flowchart for displaying a search result screen in the document management system according to the first exemplary embodiment disclosed herein.

FIG. 9 illustrates an example of the search result screen in the document management system according to the first exemplary embodiment disclosed herein.

FIG. 10 illustrates a document index generation flowchart for generating an index for a full-text search in the document management system according to the second exemplary embodiment disclosed herein.

### DESCRIPTION OF THE EMBODIMENTS

Various exemplary embodiments, features, and aspects will be described in detail below with reference to the drawings.

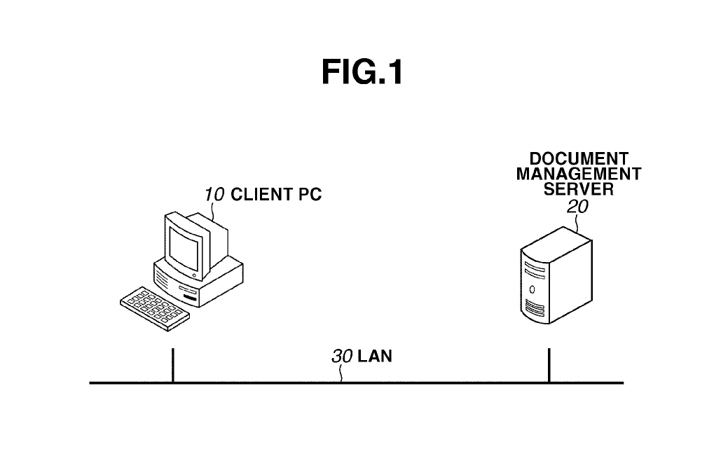

FIG. 1 illustrates a system configuration of a document management system according to a first embodiment. The document management system includes a client personal computer (PC) 10 and a document management server 20. The client PC 10 is connected to the document management server 20 via a local area network (LAN) 30.

The client PC 10 is an information processing apparatus that provides a function for operating contents by connecting to the document management server 20 via a browser. The client PC 10 enables various requests such as registering a document, viewing the document, downloading the document, and searching the document in the document management server 20 in response to a user instruction.

The document management server 20 is a document management apparatus having a document management function for managing contents such as a document or a folder and a web application server function for communication with the client PC 10 as a web server. The document management server 20 transmits a proper response to various requests from the client PC 10.

According to the present embodiment, a user operates the client PC 10. Alternatively, the user may directly operate the document management server 20. In the document management system according to the present embodiment, the user accesses the document management server 20 via the web browser of the client PC 10. However, a dedicated client application (not illustrated) may be arranged in the client PC 10, and the document management server 20 may be accessed by operating the client application.

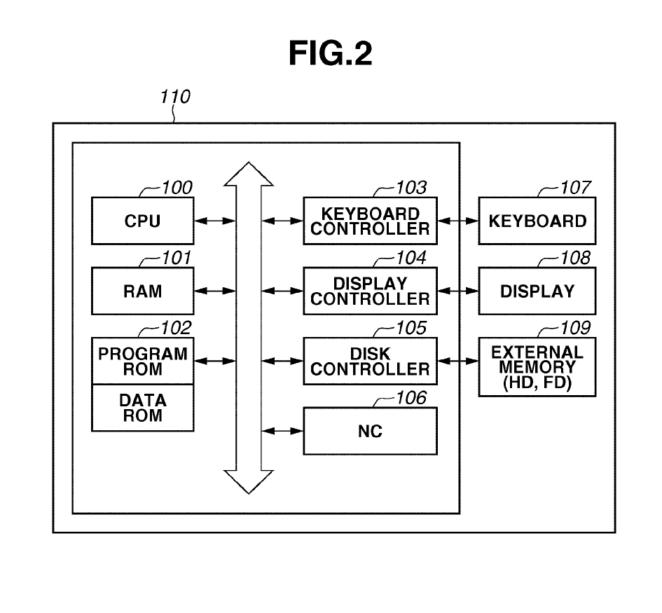

FIG. 2 illustrates a hardware configuration of a personal computer (PC) forming the document management system according to the present embodiment. A general information processing apparatus in FIG. 2 is applicable to the hardware configurations of the client PC 10 and the document management server 20.

Referring to FIG. 2, a central processing apparatus (CPU) 100 executes an operating system (OS) or a program such as an application, stored in a read only memory (ROM) 102 as a program ROM or loaded from a hard disk (HD) 109 to a random access memory (RAM) 101. Processing in flowcharts is realized by the CPU 100 executing the programs. The RAM 101 functions as a main memory or a work area of the CPU 100.

A keyboard controller 103 controls an input from a keyboard 108 or a pointing device (not illustrated) such as a mouse. A display controller 104 controls various indications of a display 107. A disk controller 105 controls data access to the hard disk (HD) 109 or a floppy (registered trademark) disk (FD) that stores various data. A network controller (NC) 106 is connected to the network to execute communication control processing with another device connected thereto.

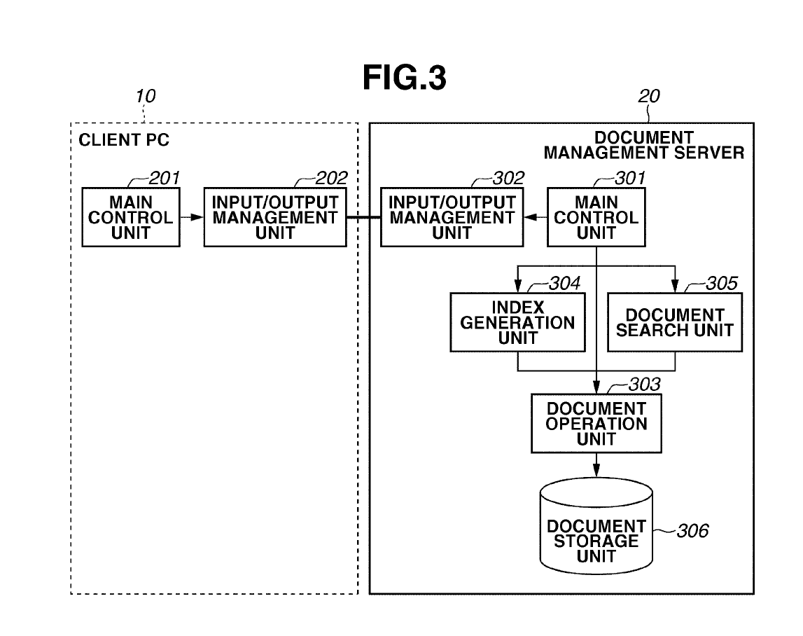

FIG. 3 illustrates a software configuration of personal computers (PCs) forming an example of the document management system according to the present embodiment. All functions of the document management system according to the present embodiment are realized by programs executed by the client PC 10 and the document management server 20.

The client PC 10 includes the following components. A main control unit 201 controls the entire client PC 10 according to the present embodiment, and gives an instruction to and manages the units. An input/output management unit 202 detects a user operation of the keyboard 108 and executes processing according to the operation. Further, the input/output management unit 202 displays data to a user interface (UI) of the display 107. Furthermore, the input/output management unit 202 receives or transmits information via the LAN 30.

The document management server 20 includes the following components. A main control unit 301 controls the entire document management server 20 according to the present embodiment, and gives an instruction to or manages the units. An input/output management unit 302 detects a user operation of the keyboard 108, and executes processing according to the operation. Further, the input/output management unit 302 displays data in the user interface (UI) of the display 107. Furthermore, the input/output management unit 302 receives or transmits information via the LAN 30.

A document operation unit 303 gives an instruction for registering, obtaining, or deleting the document in a document storage unit 306 in response to an instruction of the main control unit 301. Further, the document operation unit 303 associates the document template with the document. An index generation unit 304 generates an index for full-text search of the document template and the document registered in the document storage unit 306. A document search unit 305 performs the full-text search of the document template and the document registered in the document storage unit 306. The document storage unit 306 associates the document template with the document, and registers the document.

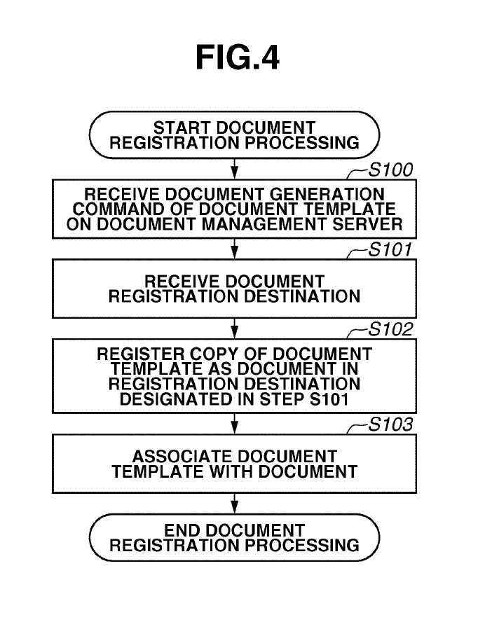

Processing of the document management system is specifically described according to the present embodiment with reference to FIGS. 4 to 9.

FIG. 4 illustrates a flowchart of document registration processing for generating the document from the document template and registering the generated document in the document management server 20 in the document management system. In step S100, the main control unit 301 receives a document generation command based on the document template registered in the document management server 20 from the client PC 10 via the input/output management unit 302.

In step S101, the main control unit 301 receives the registration destination of the document on the document management server 20 that receives the generation command in step S100 from the client PC 10 via the input/output management unit 302. In step S102, the main control unit 301 registers a copy of the document template designated in step S100 in the document storage unit 306 according to the registration destination designated in step S101 via the document operation unit 303. In step S103, the main control unit 301 associates the document template with the registered document. Further, the document is completed by a user inputting a character string to a user input portion (e.g., body text) in the registered document. As described above, the document including the character string originally included in the document template and the character string input by the user is generated. The generated document is registered in the document storage unit 306 in association with the document template.

The timing for inputting the character string by the user is not limited to this. For example, in step S100, the character string input by the user may be received together with the generation command of the document, and the document may be generated based on the received character string and the document template.

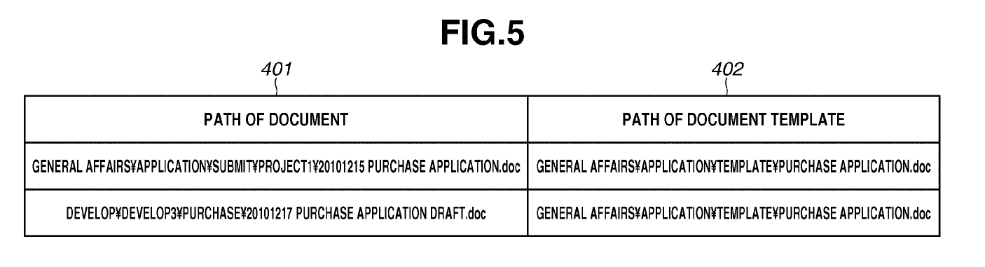

FIG. 5 illustrates an example of a data structure of association between the document template and the document in the document management system according to the present embodiment. The document template and the document are registered by setting uniquely specified paths as a pair of data to realize association between the document template and the document.

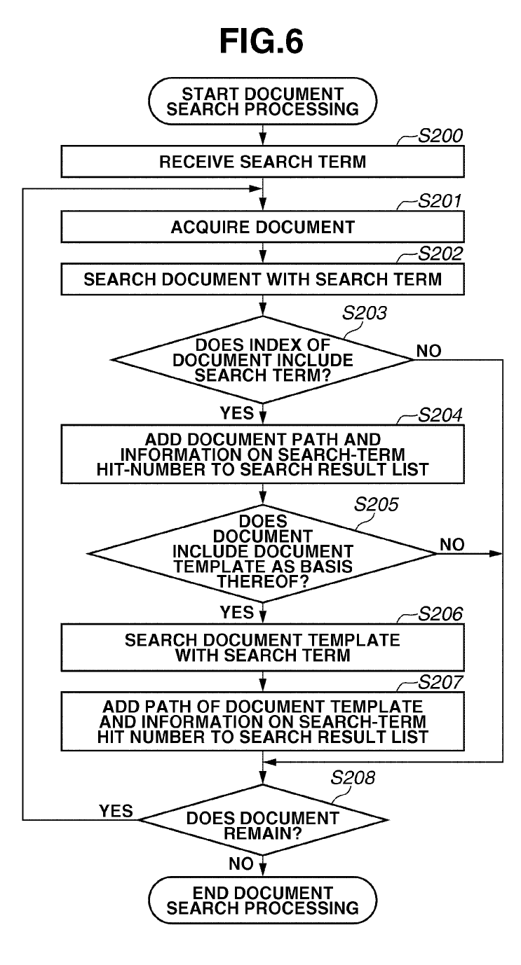

FIG. 6 illustrates a flowchart of full-text search processing of the registered document in the document management system. It is assumed that an index for full-text search of the document template and the document is generated in advance.

In step S200, the main control unit 301 receives a search term from the client PC 10 via the input/output management unit 302. In step S201, the document search unit 305 acquires a search target document from the document storage unit 306 via the document operation unit 303. In step S202, the document search unit 305 searches an index of the search target document, and acquires a search-term hit number.

In step S203, the document search unit 305 determines whether the index of the search target document includes the search term based on a search result in step S202. If the index of the search target document includes the search term (YES in step S203), the processing proceeds to step S204. If the index of the search target document does not include the search term (NO in step S203), the processing proceeds to step S208. The index for full-text search is search data in which the character included in the document is extracted. Therefore, if the search target document includes the search term, the index of the document includes the search term.

In step S204, the document search unit 305 adds the path of the search target document and information on the search-term hit number acquired in step S202 to the search result list. In step S205, the document search unit 305 determines whether the document includes the document template as its basis. If the document includes the document template as its basis (YES in step S205), the processing advances to step S206. If the document does not include the document template as the basis thereof (NO in step S205), the processing advances to step S208.

In step S206, the document search unit 305 searches an index of the document template which is the basis of the search target document, and acquires the search-term hit number. In step S207, the document search unit 305 adds the path of the document template and information on the search-term hit number acquired in step S206 to the information on the search result list added in step S204. In step S208, it is checked whether the search target document remains. If the search target document remains (YES in step S208), the processing returns to step S201 and the document search unit 305 acquires the next search target document. If the search target document does not remain (NO in step S208), the document search processing ends.

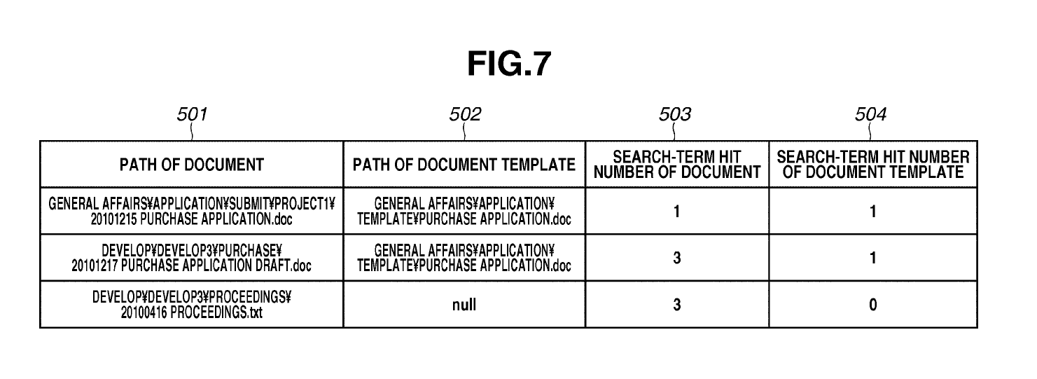

FIG. 7 illustrates an example of a data structure of the search result list. In the search result list in FIG. 7, there is a correspondence among a path 501 of the search target document determined to include the search term in step S203, a path 502 of the template document corresponding to the document, and the search-term hit numbers of the document main body and the document template. It can be determined whether a hit portion on the search term is included in the text in the document template or is specific to the document, based on a search-term hit number 503 of the document and a search-term hit number 504 of the document template.

If the search-term hit number 504 of the document template is 0 and the search-term hit number 503 of the document is 1 or more, it is determined that the search term is described only in a portion (input portion by the user) specific to the document. If the search-term hit number 504 of the document template is 1 or more and is identical to the search-term hit number 503 of the document, it is determined that the search term is described only in a portion of the document template. Further, if the search-term hit number 504 of the document template is 1 or more and the search-term hit number 503 of the document is larger than the search-term hit number 504 of the document template, the search term is described in both the portion of the document template and the portion specific to the document.

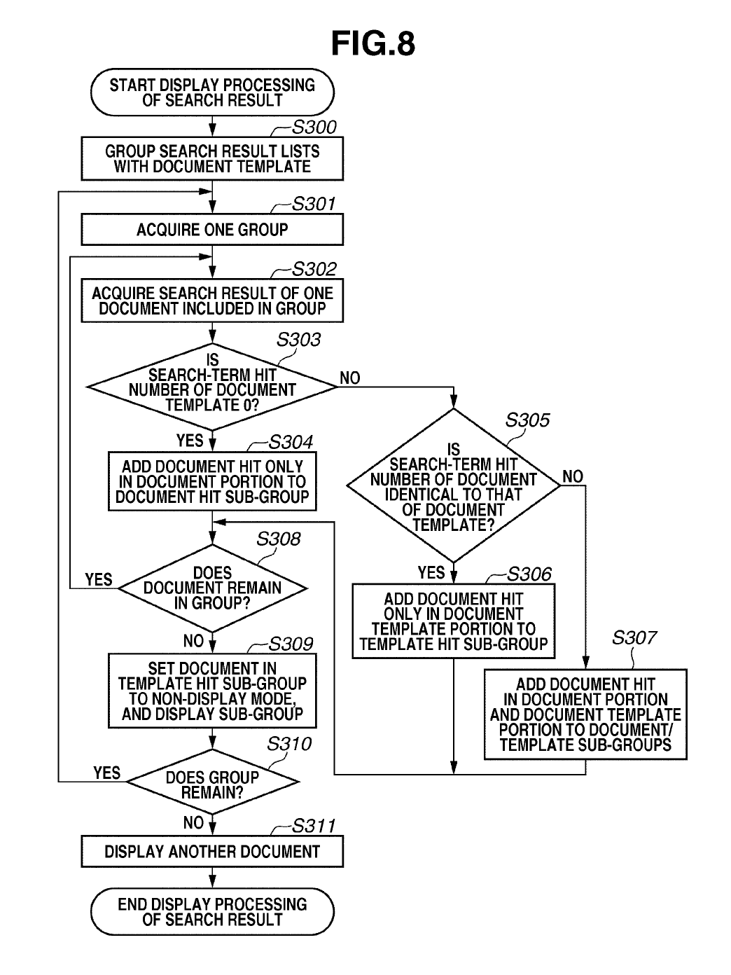

FIG. 8 illustrates a flowchart of search result display processing in the document management system according to the present embodiment. In step S300, the main control unit 301 groups the search result lists acquired by the full-text search processing in FIG. 6 with the path 502 of the document template. Specifically, a group is generated for each document template, and the documents generated from the same document template are collected as one group. The document without the corresponding document template is handled as another document.

In step S301, the main control unit 301 acquires one group as a determination target group for determining a display method of the one group, from the groups generated in step S300. In step S302, the main control unit 301 acquires a search result corresponding to one document (target document) in the documents included in the determination target group acquired in step S301, from the search result list. The acquired search result of the target document includes at least the search-term hit number 504 of the document template and the search-term hit number 503 of the document.

In step S303, the main control unit 301 determines whether the search-term hit number 504 of the acquired document template is 0. If the search-term hit number 504 of the acquired document template is 0 (YES in step S303), the processing proceeds to step S304. If the search-term hit number 504 of the acquired document template is not 0 (NO in step S303), the processing proceeds to step S305. In step S304, when the search term is hit only in the document portion, the main control unit 301 adds the target document to a document hit sub-group. The document portion refers to the one that does not exist in the document template but in a portion other than the document template of the document added to the document template by the user.

In step S305, the main control unit 301 determines whether the search-term hit number 503 of the target document is identical to the search-term hit number 504 of the document template. If the search-term hit number 503 of the target document is identical to the search-term hit number 504 of the document template (YES in step S305), the processing proceeds to step S306. If the search-term hit number 503 of the target document is not identical to the search-term hit number 504 of the document template (NO in step S305), the processing proceeds to step S307.

In step S306, the main control unit 301 sets the target document whose search-term hit number is identical to that of the document template determined in step S305 as a document in which the search term is hit only in the document template portion, and then adds the target document to a template hit sub-group. In step S307, the main control unit 301 sets the target document whose search-term hit number is not identical to that of the document template determined in step S305 as a document in which the search term is hit in both the document portion and the document template portion, and then adds the target document to the document and template hit sub-groups.

In step S308, the main control unit 301 determines whether the document whose search result is not acquired in step S302 remains in the group. If the document remains in the group (YES in step S308), the processing returns to step S302 in which a new search result of the target document is acquired. If the document does not remain (NO in step S308) in the group, the processing proceeds to step S309.

In step S309, the main control unit 301 sets the document of the template hit sub-group to a non-display mode via the input/output management unit 302, and further displays the search result for each sub-group on the display 107 in the client PC 10. In step S310, the main control unit 301 determines whether the group that is not the determination target group remains in the groups generated in step S300. If the group that is not the determination target group remains (YES in step S310), the processing returns to step S301 in which a new determination target group is acquired. If the group that is not the determination target group does not remain (NO in step S310), the processing shifts to step S311.

In step S311, the main control unit 301 displays another document that is not generated by using the document template, on the display 107 in the client PC 10 via the input/output management unit 302. Then, the search result display processing ends.

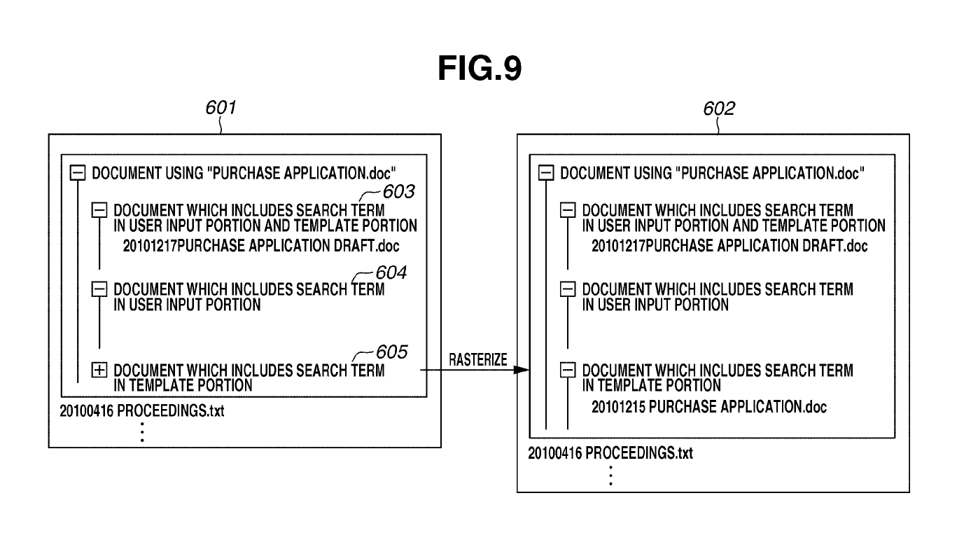

FIG. 9 illustrates an example of a search result display screen in the document management system according to the present embodiment. A search result display screen 601 displays in an identifiable manner, for each document template, a document 603 which includes the search term in the user input portion and the document template portion, a document 604 which includes the search term in the user input portion, and a document 605 which includes the search term in the document template portion. When a document has no template, the document itself such as “20100416proceedings.txt” is displayed as the search result.

The “document 603 which includes the search term in the user input portion and the document template portion” is acquired by adding the document in which the search term is hit in both the document portion and the document template portion, to the document and template hit sub-groups in the processing in FIG. 8.

The “document 604 which includes the search term in the user input portion” is acquired by adding the document which does not include the search term in the document template and is hit only in the portion specific to the document input by the user to, the document hit sub-group in the processing in FIG. 8.

The “document 605 which includes the search term in the document template portion” is acquired by adding the document which does not include the search term in the portion specific to the document and is hit only in the document template portion, to the template hit sub-group in the processing in FIG. 8.

The document 605 which includes the search term in the document template portion is displayed in the non-display mode on the search result display screen 601 that first displays the search result. By seeing the display, the user can distinguish the document which includes the search term only in the document template from the document which includes the search term in a portion other than the document template. With the user operates on the search result display screen 601 to give an instruction to rasterize the document 605 which includes the search term in the document template portion, the search result display screen 602 appears and displays the document.

According to the present embodiment, by preventing the display of all documents generated from the same document template in the full-text search, the search result can be presented according to the user's desire. Further, the search results are grouped for each document template, thereby the desired document can be easily searched.

A second embodiment of the present invention is described with reference to FIGS. 1 to 4 and 10. A system configuration, a hardware configuration, a software configuration, and document registration processing are similar to those of the document management system according to the first embodiment and are not thus described.

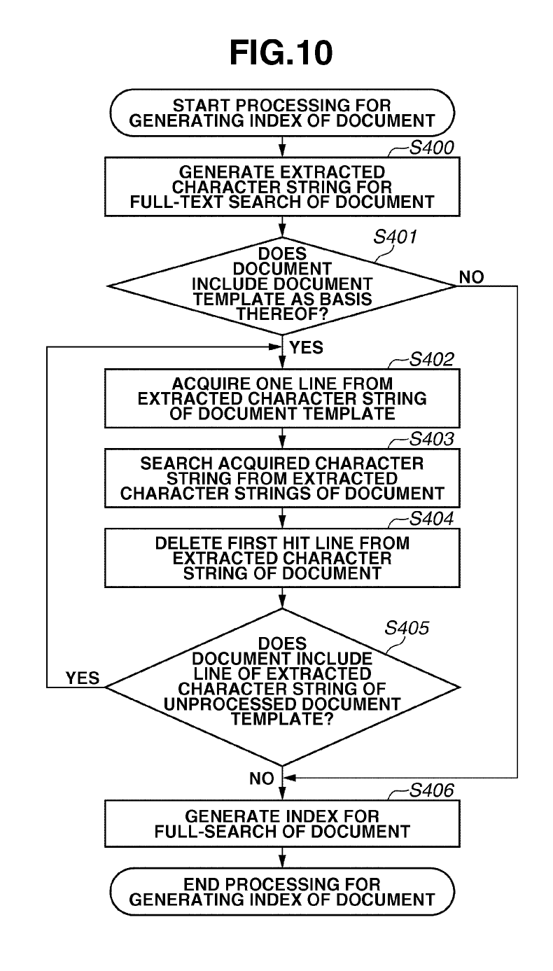

FIG. 10 illustrates a flowchart of generation processing of an index for full-text search of the document generated from the document template in the document management system according to the present embodiment. In step S400, the index generation unit 304 generates the extracted character string for full-text search of the document via the document operation unit 303. In step S401, the index generation unit 304 determines whether the document as an index generation target includes the document template as its basis via the document operation unit 303. If the document as the index generation target does not include the document template as its basis (NO in step S401), the processing proceeds to step S406. If the document of the index generation target includes the document template as the basis (YES in step S401), the processing proceeds to step S402.

In step S402, the index generation unit 304 acquires one line from the extracted character strings of the document template as the basis of the document via the document operation unit 303. In step S403, the index generation unit 304 searches the character string acquired in step S402 from the extracted character strings of the document. In step S404, the index generation unit 304 deletes the line that is first hit in the search in step S403 from the extracted character string of the document.

In step S405, the index generation unit 304 checks whether the document includes a line of the extracted character string in an unprocessed document template via the document operation unit 303. If the document includes the line of the extracted character string in the unprocessed document template (YES in step S405), the processing returns to step S402. If the document does not include the line of the extracted character string in the unprocessed document template (NO in step S405), the processing proceeds to step S406. In step S406, the index generation unit 304 generates the index for full-text search of the document from the extracted character string of the document, and stores the generated index for full-text search in the document storage unit 306 via the document operation unit 303.

The document search unit 305 searches the search term in the index for full-text search generated in the flowcharts, thereby searching the search term only in the document portion including no character string of the document template. The search result does not include the document which includes the search term only in the document template. As a consequence, the user can identify the document which includes the search term only in the document template and the document which includes the search term in the portion other than the document template.

According to the present embodiment, the index for full-text search of the document does not include the text of the document template. Therefore, it is possible to prevent the display of all documents generated from the same document template in the full-text search. Usual full-text search processing can be realized at high speed because there is not specific processing, unlike the first embodiment. Further, it is possible to reduce the data size of the index for full-text search.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to embodiments, it is to be understood that the invention is not limited to the disclosed embodiments. The scope of the following claims is to be accorded the broadest interpretation so as to encompass all modifications, equivalent structures, and functions.

This application claims priority from Japanese Patent Application No. 2011-059249 filed Mar. 17, 2011, which is hereby incorporated by reference herein in its entirety.

What is claimed is:

1. A document management system that performs a full-text search of a registered document, comprising:
a registration unit configured to register a document template and a plurality of documents generated based on the document template in association with each other;
a search unit configured to search whether each of the documents registered by the registration unit includes a search term; and
a display unit configured to display the documents including the search term, searched by the search unit, as a search result,
wherein the display unit displays, in an identifiable manner, a document that includes the search term only in a portion corresponding to the document template and a document that includes the search term in a portion other than the document template, with respect to the documents including the search term.

2. The document management system according to claim 1, further comprising:
an acquisition unit configured to acquire, for each of the documents including the search term searched by the search unit, a search-term hit number for the entire document and a search-term hit number for the document template corresponding to the document; and
a determination unit configured to determine the document as the document that includes the search term only in the portion corresponding to the document template when the search-term hit number of the entire document is identical to the search-term hit number of the document template, and further determine the document as the document that includes the search term also in the portion other than the document template when the search-term hit number of the entire document is not identical to the search-term hit number of the document template.

3. The document management system according to claim 1, wherein the display unit displays in an identifiable manner the document that includes the search term only in the portion corresponding to the document template, a document that does not include the search term in the portion corresponding to the document template but includes the search term only in the portion other than the document template, and a document that includes the search term in both the portion corresponding to the document template and the portion other than the document template, with respect to the documents including the search term.

4. The document management system according to claim 3, further comprising:
an acquisition unit configured to acquire, for each of the documents including the search term searched by the search unit, a search-term hit number for the entire document and a search-term hit number for the document template corresponding to the document; and
a determination unit configured to determine the document as the document that does not include the search term in the portion corresponding to the document template but includes the search term only in the portion other than the document template when the search-term hit number for the document template is 0, further determine the document as the document that includes the search term only in the portion corresponding to the document template when the search-term hit number for the document template is not 0 and the search-term hit number of the entire document is identical to the search-term hit number of the document template, and furthermore determine the document as the document that includes the search term in both the portion corresponding to the document template and the portion other than the document template when the search-term hit number for the document template is not 0 and the search-term hit number for the entire document is not identical to the search-term hit number for the document template.

5. The document management system according to claim 1, further comprising:
a generation unit configured to generate an index for the full-text search corresponding to the document,
wherein the generation unit generates an index by deleting a character string of the document template from the document, and
the search unit searches whether the search term is included in a portion other than the document template, by searching the index generated by the generation unit.

6. The document management system according to claim 1, wherein the display unit displays the search result while putting the document that includes the search term only in the portion corresponding to the document template, in a non-display mode, among the documents including the search term.

7. A document management method of a document management system that enables a full-text search of a registered document, the method comprising:
registering a document template and a plurality of documents generated based on the document template in association with each other;
searching whether each of the documents registered by the registration unit includes a search term; and
displaying the documents including the searched search term as a search result,
wherein when the documents including the searched term are displayed, a document that includes the search term only in a portion corresponding to the document template and a document that includes the search term in a portion other than the document template are displayed in an identifiable manner.

8. The document management method according to claim 7, further comprising:
acquiring, for each of the documents including the search term, a search-term hit number for the entire document and a search-term hit number for the document template corresponding to the document; and
determining the document as the document that includes the search term only in the portion corresponding to the document template when the search-term hit number for the entire document is identical to the search-term hit number for the document template, and further determining the document as the document that includes the search term also in the portion other than the document template when the search-term hit number for the entire document is not identical to the search-term hit number for the document template.

9. The document management method according to claim 7, wherein when the documents including the searched term are displayed, the document that includes the search term only in the portion corresponding to the document template, a document that does not include the search term in the portion corresponding to the document template but include the search term only in the portion other than the document template, and a document that includes the search term in both the portion corresponding to the document template and the portion other than the document template, are displayed in an identifiable manner.

10. The document management method according to claim 9, further comprising:
acquiring, for each of the documents including the search term, a search-term hit number of the entire document and a search-term hit number of the document template corresponding to the document; and
determining the document as the document that does not include the search term in the portion corresponding to the document template but includes the search term only in the portion other than the document template when the search-term hit number for the document template is 0, further determining the document as the document that includes the search term only in the portion corresponding to the document template when the search-term hit number for the document template is not 0 and the search-term hit number of the entire document is identical to the search-term hit number for the document template, and furthermore determining the document as the document that includes the search term in both the portion corresponding to the document template and the portion other than the document template when the search-term hit number for the document template is not 0 and the search-term hit number for the entire document is not identical to the search-term hit number of the document template.

11. The document management method according to claim 7, further comprising:
generating an index for full-text search corresponding to the document,
wherein an index obtained by deleting a character string of the document template is generated from the document in the generation of the index, and
searching whether the search term is included in the portion other than the document template by searching the generated index in the search.

12. The document management method according to claim 7, wherein the search result is displayed in a non-display mode of the document that includes the search term only in the portion corresponding to the document template, among the documents including the search term in the display.

13. A non-transitory computer-readable storage medium storing a computer program, the computer program configured to cause a computer to execute the document management method according to claim 7.
